(19) United States
(12) Patent Application Publication
(10) Pub. No.: US 2026/0278047 A1
(43) Pub. Date: Sep. 17, 2026

(54) AUTOMATION PLATFORM CONFIGURATION FOR USER ACCESS AUTHENTICATION

(71) Applicant: Schneider Electric Systems USA, Inc., Foxborough, MA (US)

(72) Inventors: James Redmond, Richmond (CA); Zackery Sobin, Tryon, NC (US)

(21) Appl. No.: 19/081,648

(22) Filed: Mar. 17, 2025

(51) Int. Cl. G06F 21/31

(52) U.S. Cl. CPC G06F 21/31

(57) ABSTRACT

A system and method for using automation platform configuration for access control in an industrial automation system. An authentication processor receives an authentication request to access and industrial automation device from a client. The access request includes authentication configuration information which includes a previous automation platform configuration. The access request optionally also includes client credentials. The authentication processor validates the client credentials if present and optionally performs a two-factor authentication. The authentication processor validates the authentication configuration information by comparing the information to the currently applied automation platform configuration. The authentication processor gives access to the industrial automation device or a component of the device based on the authentication configuration information containing the entire automation platform configuration or the components configuration.

### BACKGROUND

Traditional operations technology (OT) systems often lack robust security for the equipment within the system. In industrial automation systems, various factors make comprehensive security and authentication systems burdensome to operators and can decrease efficiency. For example, changing personnel and equipment brings complexities to maintaining traditional authentication for industrial automation systems. In another example, requiring additional configuration for each device or adding many different users in various roles to the appropriate systems can present difficulties. Providing general credentials for use across the system regardless of user or client presents security risks, in that a breach of one device leads to a breach of all devices within the system.

### SUMMARY

Aspects of the present disclosure provide a system for authenticating access to an industrial automation device using the automation platform configuration. The authentication processor receives a request including authentication configuration information which includes a previously applied automation platform configuration. The authentication processor additionally may perform traditional authentication measures such as client credentials with or without two-factor authentication. The access request is validated by comparing the authentication configuration information to the currently applied automation platform configuration. Based on the comparison, the authentication processor grants or denies access to the industrial automation device in its entirety or, alternatively, to a component of the industrial automation device.

In an aspect, a method for enabling secure access to an industrial automation device includes receiving, from a client, an access request to an industrial automation device. The access request includes authentication configuration information associated with the industrial automation device. The authentication configuration information includes one or more settings associated with the industrial automation device. The method also includes comparing the authentication configuration information to current automation platform configuration information on the industrial automation device. The current automation platform configuration information includes one or more current settings associated with and currently applied to the industrial automation device. In response to the authentication configuration information matching the current automation platform configuration information on the industrial automation device, the method further includes, granting the client access to the industrial automation device. The method also includes, in response to the authentication configuration information failing to match the current automation platform configuration information on the industrial automation device, denying the client access to the industrial automation device.

In another aspect, an industrial automation device comprises an authentication processor and an authentication database communicatively coupled to the processor. The authentication database stores current automation platform configuration information. When executed by the authentication processor, computer-executable instruction stored in the memory configure the authentication processor for receiving, from a client, a request to access the industrial automation device. The request for access includes authentication configuration information. The authentication configuration information includes one or more settings associated with the industrial automation device. The instructions when executed further configure the authentication processor for comparing the authentication configuration information to the current automation platform configuration information. The current automation platform configuration information includes one or more current settings associated with and currently applied to the industrial automation device. The instructions when executed also configure the authentication processor for, in response the authentication configuration information matching the current automation platform configuration information, granting the client access to the industrial automation device and in response to the authentication configuration information not matching the current automation platform configuration information, denying the client access to the industrial automation device.

In yet another aspect, a system for enabling secure access to a component of an industrial automation device includes an authentication processor, a first component of an industrial automation device communicatively coupled to the authentication processor, and a second component of an industrial automation device communicatively coupled to the authentication processor. The system also includes an authentication database communicatively coupled to the processor. The authentication database stores first current configuration information. The first current configuration information includes one or more current settings associated with and currently applied to the first component. The authentication database also stores second current configuration information. The second current configuration information includes one or more current settings associated with and currently applied to the second component. The system also includes a memory. The memory stores computer-executable instructions that, when executed by the authentication processor, configure the authentication processor for receiving, from a client, a request to access the industrial automation device. The request for access includes authentication configuration information and the authentication configuration information includes one or more settings associated with the industrial automation device. The executed instructions also include comparing the authentication configuration information to the current configuration information. The current configuration information includes one or more current settings associated with and currently applied to the industrial automation device. The executed instructions further include, in response the authentication configuration information matching the first current configuration information, granting the client access to the first component of the industrial automation device. The instructions also include, in response to the authentication configuration information matching the second current configuration information, granting the client access to the second component of the industrial automation device.

Other objects and features of the present invention will be in part apparent and in part pointed out herein.

### BRIEF DESCRIPTION OF THE DRAWINGS

FIG. 1 is a block diagram illustrating a system for authenticating access to an industrial automation device using automation platform configuration information according to an embodiment.

FIG. 2 is a flow diagram of a process using automation platform configuration in authenticating access to an industrial automation device according to an embodiment.

FIG. 3A is an example configuration file according to an embodiment.

FIG. 3B is an example hash of the configuration file shown in FIG. 3A.

FIG. 4 is a flow diagram of a process of applying an automation platform configuration and generating authentication configuration information according to an embodiment.

FIG. 5 is a block diagram illustrating a computer system according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

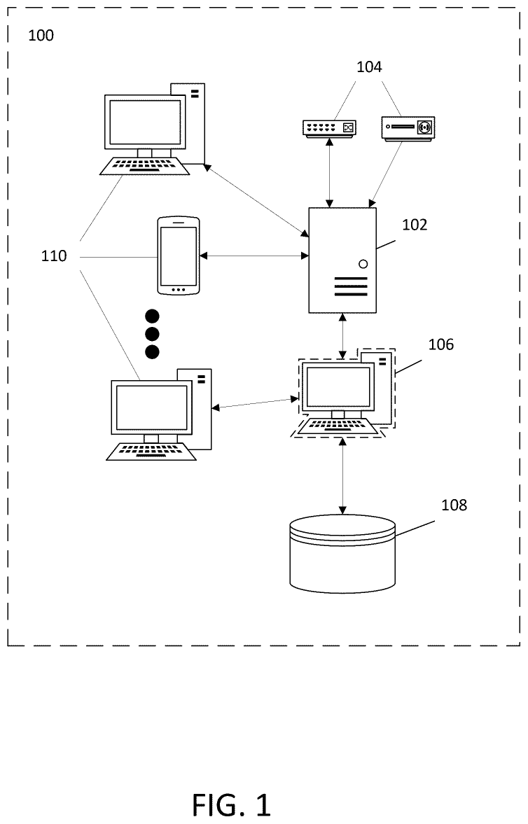

Referring to the figures and description below, a system 100 for using automation platform configuration as a factor in authentication for an industrial automation system is disclosed. FIG. 1 is a block diagram illustrating the system 100. The industrial automation system includes an industrial automation device 102. Industrial automation device 102 may include any device in the industrial automation process such as controllers, processors, sensors, or other types of robotics. In some embodiments, the industrial automation device 102 connects to a local network through a wired connection or a wireless connection such as WiFi or Bluetooth. In other embodiments, the industrial automation device 102 connects to a global network using a wired connection or WiFi.

In some embodiments, one or more components 104, such as temperature sensors, current sensors, network interfaces, and the like, are coupled to industrial automation device 102. The industrial automation device 102 includes an automation platform configuration which includes various settings configuring its behavior, such as settings for when to issue an alarm, what action to take in response to certain system input, or network configuration. Similarly, each component 104 may include its own settings related to its function. For example, the industrial automation device 102 may be part of a distributed control system (DCS). The DCS controls many other components of the industrial automation system and the components of the DCS each have their own settings for configuration. In some embodiments, the industrial automation device 102 further couples with input and output devices such as a keyboard, a mouse, and/or a display.

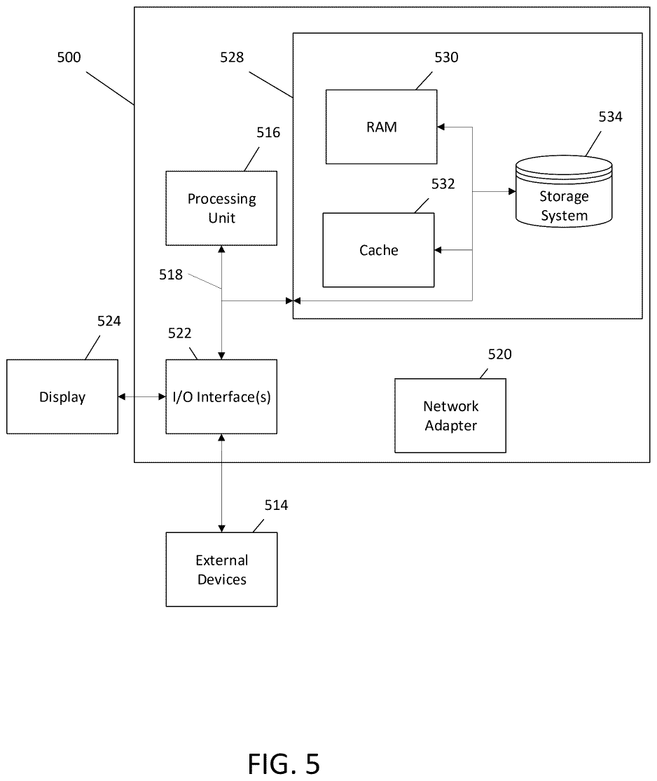

The industrial automation device 102 includes security mechanisms to prevent unauthorized access. The authentication processor 106 handles authentication requests between client devices 110 and industrial automation devices 102 within the industrial automation system. In some embodiments, the authentication processor 106 is a component of the industrial automation device 102. The authentication processor 106 couples with a memory storing instructions for performing authentication. During access requests, further described below, the authentication processor 106 validates a request and determines whether access should be granted to the industrial automation device 102 as a whole, a sub set of components 104 of the device 102, or a single component 104 of the device 102. In some embodiments, the authentication processor 106 processes authentication requests received on the industrial automation device 102 itself. The authentication processor 106 grants access, further described below, based on authentication configuration information, which includes a previous automation platform configuration for the industrial automation device 102 or components 104 of the device 102. In some embodiments, one or more of the authentication processor 106 and/or one or more of the client devices 110 are implemented using a computer system as shown and described in FIG. 5, discussed further herein.

In some embodiments, the authentication processor 106 also authenticates a client device 110 or user of the industrial automation device using client credentials. In one or more embodiments, the authentication system further includes two-factor authentication utilizing a method such as a PIN code or push notification. In yet another embodiment, the authentication system also includes role-based credential authentication. Under role-based credential authentication, a client device 110 or user only receives access based on their associated role. As a result, a role may only enable access to control certain components of the system. For example, an industrial automation device 102 may include network components such as an Ethernet port or WiFi adapter, such components include specific settings for their network configuration. While general plant operators may have access to configure the sensors or controllers of the industrial automation device 102, they may be restricted from configuring the network components. Similarly, information technology personnel may have access to configure the network components but are restricted from controlling other components 104 of the device 102.

Because each device 102 and component 104 includes an automation platform configuration of settings, these settings can be further leveraged for authenticating a user. Since the settings may cover many different elements and require authentication to access or configure, a user would need to have had previously configured the settings or receive a configuration file from someone who has in order to have a matching configuration file. This configuration file can provide either an alternative method of authorization or a supplemental layer of security. By using a configuration file as a complete method for authenticating, a user who has previously configured the device can share access to another user who needs access. This enables quick access for other industrial system personnel without creating additional credentials on the system for each potential user. Alternatively, the configuration information can supplement existing authentication methods by acting as a second or even third factor of authentication. For example, the industrial automation device 102 may require that an access request still includes client credentials. The device 102 also may optionally solicit a common two-factor authentication operation such as sending a push notification or PIN code to the client. While push notification and PIN code are mentioned, any other form of two-factor authentication could be implemented in addition to the configuration information based authentication.

In some embodiments, authentication configuration information acts as a role-based authentication in place of configured roles. For example, the authentication processor 106, upon validating the client credentials, may first validate authentication configuration information before checking the client role. If the authentication configuration information provides access to the device 102, generally, or components 104, specifically, the authentication processor 106 grants access to the components without checking the client role. As a result, users who previously made changes to a device 102 may pass off access to that device 102 without assigning a role to another user by giving the other user the authentication configuration information.

The authentication processor 106 couples with an authentication database 108. The authentication database 108 stores authentication information. In some embodiments, the authentication database 108 stores data locally on the industrial automation device 102. In one embodiment, the authentication database 108 and authentication processor 106 reside as components of a single computer system. In other embodiments, the authentication database 108 resides on other infrastructure within the industrial automation system facility. In yet another embodiment, the authentication database 108 operates on infrastructure within the cloud. In some embodiments, the authentication database 108 stores device configuration information. The stored configuration information may include device 102 or component 104 settings. Alternatively, the stored configuration information may include hashes of configuration files. In some embodiments, the stored hashes of configuration files may be salted before being hashed, thus increasing protection. In other embodiments, the authentication database 108 stores valid client credentials. Further, in one or more embodiments, the authentication database stores client and role information for role-based authentication.

In some embodiments, multiple client devices 110 are configured to connect to the network of an industrial automation system. In one embodiment, shown in FIG. 1, client devices 110 communicate and connect through a local network. In other embodiments, the client devices 110 connect through a global network such as the internet. In some embodiments, network communication between the devices may be through a hard line such as Ethernet or other network link. In other embodiments, devices may communicate wirelessly through Wi-Fi or Bluetooth. In an embodiment, client devices 110 may also represent other industrial automation devices 102 involved in the industrial automation process such as controllers, processors, sensors, or other types of robotics. In another embodiment, client devices 110 comprise operator devices such as a smart phone, tablet, desktop, laptop, or other computer system. In some embodiments, the client devices 110 request access to the industrial automation device 102 or its components 104.

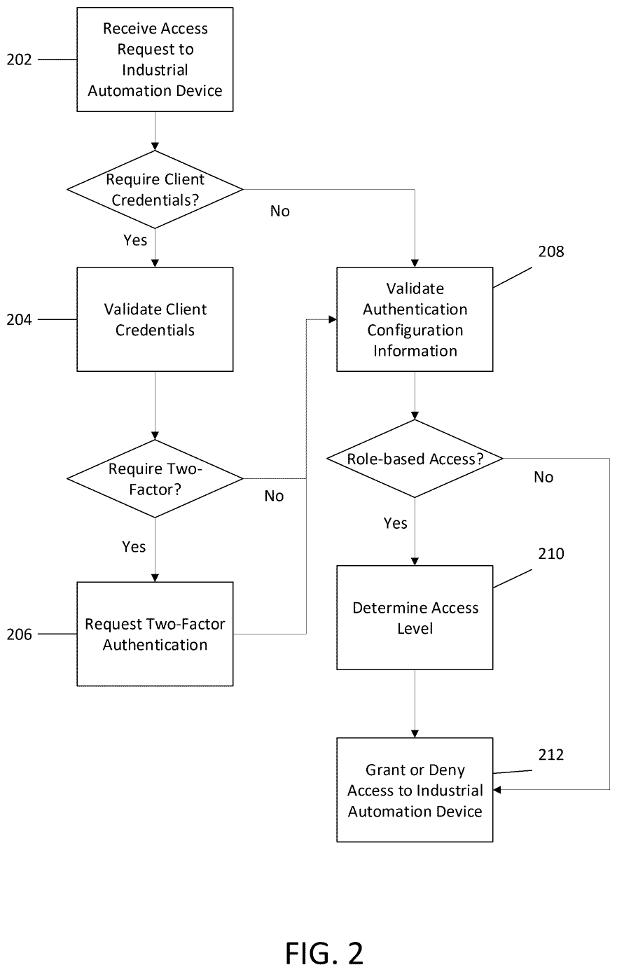

FIG. 2 is a flow diagram illustrating the process of authenticating a client device 110 or user accessing an industrial automation device 102 using automation platform configuration. First, at step 202, the authentication processor 106 receives a request to access the industrial automation device 102. In some embodiments, the access request comes from a client device 110. In other embodiments, a user directly accesses the industrial automation device 102 using an input device such as a keyboard. In one or more embodiments, the client device 110 includes a touch screen for providing an input to access the industrial automation device 102. In one embodiment, the access request includes information regarding the components 104 targeted by the access request.

The access request includes authentication configuration information, which includes a previous automation platform configuration. In one embodiment, the authentication configuration information is a configuration file of the automation platform configuration. In one or more embodiments, the configuration file is stored in a structured format such as XML. In other embodiments, the authentication configuration information is a hash of the configuration file, which may or may not be salted prior to hashing. In one or more embodiments, the access request further includes a client credential including a username and password. While hashed and non-hashed configuration files are illustrated as authentication configuration information, the authentication configuration information may be any format for maintaining the configuration settings of the industrial automation device 102 and/or its components 104.

Continuing with reference to FIG. 2, after receiving the access request, the authentication processor 106 proceeds to validate the request. If the access request requires client credentials, the authentication processor 106 validates the credentials against stored credentials within the authentication database 108 at step 204. Otherwise, validation proceeds with evaluating the authentication configuration information at step 208. If the credentials fail to match stored credentials, the access request is denied. If the credentials are valid, the process continues. While credential authentication is illustrated as occurring before validation of the authentication configuration information, the steps may be performed in any order. For example, the authentication processor 106 may validate the authentication configuration information and only proceed to validating credentials if the authentication configuration information is valid. Alternatively, the authentication processor 106 may skip generally required credential authentication if the authentication configuration information is valid.

After validating client credentials, if two-factor authentication is enabled, then a two-factor authentication request is sent to the client at step 206. For example, the authentication processor 106 sends a PIN code to the client device 110 or the personal device of the user accessing the industrial automation device 102. If two-factor authentication is not required or a successful two-factor authentication response is received, the validation process continues to step 208. Like the credential validation step, the two-factor authentication step may occur after validation of the authentication configuration information. In some embodiments, if both the client credentials and authentication configuration information are determined to be valid, the authentication processor 106 may skip an optional two-factor authentication step that would otherwise be required.

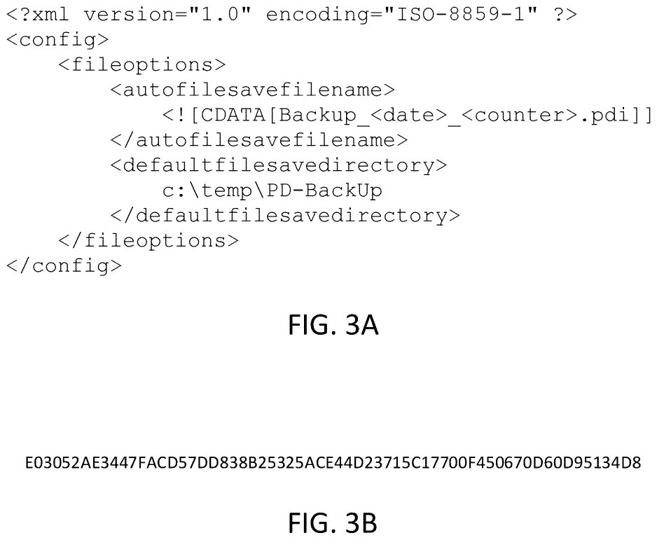

At step 208, the authentication processor 106 validates the authentication configuration information. In some embodiments, the authentication configuration information includes the full automation platform configuration for the industrial automation device 102. In other embodiments, the authentication configuration information includes settings to one or more components 104 of the industrial automation device 102. If the authentication configuration information includes a configuration file of settings, the authentication processor 106 compares the authentication configuration information to a configuration file of the current automation platform configuration. FIG. 3A illustrates an example of a configuration file according to an embodiment. If the authentication database 108 stores the configuration file, the authentication processor 106 retrieves the file. Otherwise, the authentication processor 106 generates a new configuration file based off the currently automation platform configuration. If the authentication configuration file represents a subset of settings to the device 102 such as specific components 104, the authentication processor 106 compares the authentication configuration file to a configuration file containing currently applied settings for those specific components 104.

Still referring to step 208, in one or more embodiments, rather than the authentication configuration information including a configuration file, the information includes a hash of a configuration file. FIG. 3B illustrates an example hash of a configuration file. In some embodiments, the hash of the configuration file has been salted with random characters before hashing. In other embodiments, the authentication configuration information may include information secured using symmetric encryption or asymmetric encryption using one or more keys or certificates. If the authentication configuration information comprises a hash of a configuration file, the authentication processor 106 retrieves a hash of the current settings from the authentication database 108 or generates a new hash by generating a new configuration file and hashing the generated file. If the salting is required, the authentication processor 106 applies the salt, including several randomly generated characters, before hashing the generated configuration file.

In some embodiments, the authentication processor 106 evaluates the client role to determine what if any portion of the industrial automation device 102 or components 104 to grant access at step 210. The authentication processor 106 evaluates the role of the requesting user or client within the authentication database 108. Based on the role the authentication processor 106 determines which components 104 to grant access to or whether to grant access to the device 102 as a whole. Further, the authentication processor 106 determines a level of control based on the role, such as read-only or administrative access. In one or more embodiments, while the authentication system includes role-based authentication, the authentication processor 106, rather than evaluating the client role, determines an access level based solely on the authentication configuration information. For example, a user may give another user a configuration file containing settings for a component of the DCS. Even if the role of the second user does not ordinarily provide access to the component of the DCS, the second user can still be granted access based on providing the configuration file of that component.

At step 212, the authentication processor 106 grants or denies access to the industrial automation device 102. In some embodiments, if in any prior implemented step during the validation process fails, the authentication processor 106 denies access to the industrial automation device 102. For example, if the authentication system implements both client credentials and two-factor authentication along with validation of authentication configuration information, the client must submit valid credentials, complete the two-factor authentication, and provide valid authentication configuration information to gain access to the industrial automation device 102.

In other embodiments, if only authentication configuration information was required and provided, the authentication processor 106 requests for authentication credentials in response to the authentication configuration information not matching the current settings. As a result, if the settings of the industrial automation device 102 were changed by another user and not shared, the requesting user could still access the industrial automation device 102. In some embodiments, the authentication processor 106 only grants access to specific components 104 of the industrial automation system 102. For example, if the authentication configuration information included only a configuration file with settings for certain components of the DCS, the authentication processor 106 grants access only to configure those components. However, if the authentication configuration information includes a complete set of settings for the industrial automation device 102, the authentication processor 106 grants access to the entire device 102.

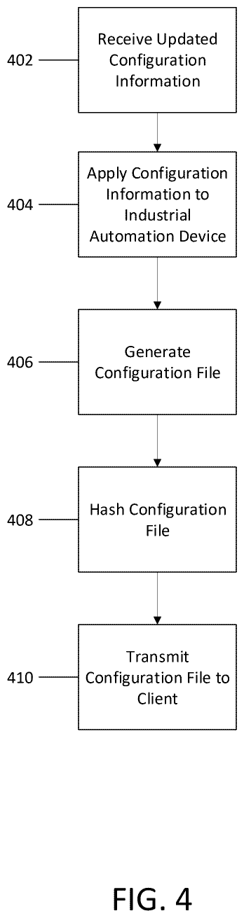

FIG. 4 is a flow diagram illustrating the process of updating settings on the industrial automation device 102 and generating authentication configuration information. At step 402, the industrial automation device 102 receives configuration information. In some embodiments, the configuration information includes an input received through an input device such as a mouse or keyboard connected to the industrial automation device. In other embodiments, the configuration information includes an updated configuration file with multiple settings for the industrial automation device 102.

After receiving the configuration information, the industrial automation device 102 applies the settings received at step 404. The settings may be applied to the device 102 generally or to specific components 104. At step 406, following the application of the settings the industrial automation device 102 generates a new configuration file. The new configuration file includes the settings which were just applied to the industrial automation device 102. As a result, older authentication configuration information previously generated implicitly expires as the information no longer reflects the settings on the industrial automation device 102. The new configuration file may also include other settings of the industrial automation device 102 which were not configured but are required as a part of the complete automation platform configuration.

After generating the new configuration file, if hashing is required, the industrial automation device 102 generates the hash of the new configuration file at step 408. Hashing may be performed using a hash algorithm such as MD5, SHA, or SHA-256, however, any other hashing mechanism may be used. Hashing the configuration file ensures can provide a layer of security while primarily creating a lighter weight solution for providing authentication configuration information. FIG. 3B shows an example of a hash of the example configuration file. As can be seen the client configuration file hash represents a smaller set of data to maintain for access than even a basic configuration file. Rather than having to maintain a configuration file of variable size depending on the amount of settings for the industrial automation device 102, a client need only maintain the hash to retain access.

Finally, the updated configuration information is transmitted to the client at step 410. In some embodiments, the updated configuration information consists only of a non-hashed XML configuration file to provide quick and easy authentication. The client retains the configuration information, either a hash or configuration file, to maintain access to the industrial automation device 102. By using configuration information for access control enables easy transfer of access to other user while maintaining a layer of security within the industrial automation system. The user can then maintain a copy of the authentication configuration information on the user's personal device such as a smart phone, laptop, tablet, or USB drive for easy use for the next access request.

Embodiments of the present disclosure may comprise a special purpose computer including a variety of computer hardware, as described in greater detail herein.

Computer system 500 is shown in FIG. 5 in the form of a general-purpose computing device. The components of computer system 500 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 500 typically includes a variety of computer system readable media. Such media may be any available media that is accessible by computer system 500, and it includes both volatile and non-volatile media, removable and non-removable media.

System memory 528 can include computer system readable media in the form of volatile memory, such as random-access memory (RAM) 530 and/or cache memory 532. Computer system 500 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the disclosure.

Computer system 500 may also communicate with one or more external devices 514 such as a keyboard, a pointing device, a display 524, etc.; one or more devices that enable a user to interact with computer system 500; and/or any devices (e.g., network card, modem, etc.) that enable computer system 500 to communicate with one or more other computing devices. Such communication can occur via Input/Output (I/O) interfaces 522. Still yet, computer system 500 can communicate with one or more networks such as a LAN, a general WAN, and/or a public network (e.g., the Internet) via network adapter 520. As depicted, network adapter 520 communicates with the other components of a network (not shown) via bus 518. It should be understood that although not shown, other hardware and/or software components could be used in conjunction with computer system 500. Examples, include, but are not limited to: microcode, device drivers, redundant processing units, external disk drive arrays, RAID systems, tape drives, and data archival storage systems, and so on.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A method for enabling secure access to an industrial automation device, the method comprising:
receiving, from a client, an access request to the industrial automation device, the access request comprising authentication configuration information associated with the industrial automation device, and the authentication configuration information comprising one or more settings associated with the industrial automation device;
comparing the authentication configuration information to current automation platform configuration information on the industrial automation device, the current automation platform configuration information comprising one or more current settings associated with and currently applied to the industrial automation device;
in response to the authentication configuration information matching the current automation platform configuration information on the industrial automation device, granting the client access to the industrial automation device; and
in response to the authentication configuration information failing to match the current automation platform configuration information on the industrial automation device, denying the client access to the industrial automation device.

2. The method of claim 1, further comprising:
in response to the authentication configuration information of the access request failing to match the current automation platform configuration information on the industrial automation device, requesting a role-based credential authentication.

3. The method of claim 1, further comprising validating, after receiving the access request, a client credential, wherein the access request further comprises the client credential.

4. The method of claim 1, further comprising:
receiving, in response to granting the client access to the industrial automation device, one or more updated configuration settings;
applying, to the industrial automation device, the updated configuration settings;
generating, by the industrial automation device, updated configuration information comprising the updated configuration settings; and
transmitting, to the client, the updated configuration information.

5. The method of claim 1, wherein the authentication configuration information comprises a client configuration file hash of the one or more settings associated with the industrial automation device and the current automation platform configuration information comprises a current configuration file hash of the one or more current settings applied to the industrial automation device.

6. The method of claim 5, further comprising:
receiving, in response to granting the client access to the industrial automation device, one or more updated configuration settings;
generating, by the industrial automation device, updated configuration information comprising the updated configuration settings;
applying, to the industrial automation device, the updated configuration settings;
generating, by the industrial automation device, a hash of the updated configuration information; and
transmitting, to the client, the hash of the updated configuration information.

7. The method of claim 6, further comprising salting, prior to generating the hash, the updated configuration information.

8. The method of claim 1, wherein the authentication configuration information comprises at least one of symmetrically encrypted configuration information or asymmetrically encrypted configuration information and wherein the authentication configuration information is encrypted using at least one of one or more keys or one or more certificates.

9. The method of claim 1, wherein receiving the access request comprises receiving the access request from at least one of a user or a requesting client device.

10. An industrial automation device comprising:
an authentication processor;
an authentication database communicatively coupled to the processor, the authentication database storing current automation platform configuration information;
a memory storing computer-executable instructions that, when executed by the authentication processor, configure the authentication processor for:
receiving, from a client, a request to access the industrial automation device, the request for access comprising authentication configuration information, and the authentication configuration information comprising one or more settings associated with the industrial automation device;
comparing the authentication configuration information to the current automation platform configuration information, the current automation platform configuration information comprising one or more current settings associated with and currently applied to the industrial automation device;
in response the authentication configuration information matching the current automation platform configuration information, granting the client access to the industrial automation device; and
in response to the authentication configuration information not matching the current automation platform configuration information, denying the client access to the industrial automation device.

11. The industrial automation device of claim 10, wherein the computer-executable instructions stored in the memory, when executed by the authentication processor, further configure authentication processor for:
in response to the authentication configuration information not matching the current automation platform configuration information, requesting a authentication credential from the client;
receiving, from the client, the authentication credential;
validating the authentication credential; and
in response to validation of the authentication credential, granting the client access to the industrial automation device.

12. The industrial automation device of claim 10, wherein the request to access the industrial automation device comprises a client credential, wherein the authentication database further stores a plurality of valid client credentials, and wherein the computer-executable instructions stored in the memory, when executed by the processor, further configure processor for validating the client credential against the stored valid client credentials.

13. The industrial automation device of claim 10, wherein the computer-executable instructions stored in the memory, when executed by the authentication processor, further configure authentication processor for:
soliciting, after receiving the request to access, a two-factor authentication response from the client, wherein the two-factor authentication response comprises at least one of a push notification or a PIN code.

14. The industrial automation device of claim 10, wherein the computer-executable instructions stored in the memory, when executed by the authentication processor, further configure authentication processor for:
receiving, in response to granting the client access to the industrial automation device, one or more updated configuration settings from the client;
generating updated configuration information, the updated configuration information comprising the updated configuration settings; and
transmitting, to the client, the updated configuration information.

15. The industrial automation device of claim 10, wherein the authentication configuration information comprises a client configuration file hash of the one or more settings associated with the industrial automation device and the current automation platform configuration information comprises a current configuration file hash of the one or more current settings applied to the industrial automation device.

16. The industrial automation device of claim 15, wherein the computer-executable instructions stored in the memory, when executed by the authentication processor, further configure authentication processor for:
receiving, in response to granting the client access to the industrial automation device, one or more updated configuration settings;
generating, by the industrial automation device, updated configuration information comprising the updated configuration settings;
generating, by the industrial automation device, a hash of the updated configuration information; and
transmitting to the hash of the updated configuration information.

17. A system for enabling secure access to a component of an industrial automation device, the system comprising:
an authentication processor;
a first component of an industrial automation device communicatively coupled to the authentication processor;
a second component of an industrial automation device communicatively coupled to the authentication processor;
an authentication database communicatively coupled to the processor, the authentication database storing:
first current configuration information comprising one or more current settings associated with and currently applied to the first component; and
second current configuration information comprising one or more current settings associated with and currently applied to the second component;
a memory storing computer-executable instructions that, when executed by the authentication processor, configure the authentication processor for:
receiving, from a client, a request to access the industrial automation device, the request for access comprising authentication configuration information, and the authentication configuration information comprising one or more settings associated with the industrial automation device;
comparing the authentication configuration information to the first current configuration information and the second current configuration information;
in response the authentication configuration information containing the first current configuration information, granting the client access to the first component of the industrial automation device; and
in response to the authentication configuration information containing the second current configuration information, granting the client access to the second component of the industrial automation device.

18. The system of claim 17, wherein the authentication configuration information comprises a client configuration file hash of the one or more settings associated with the component of the industrial automation device, the first current configuration information comprises a current configuration file hash of the one or more current settings applied to the first component of the industrial automation device, and the second current configuration information comprises a current configuration file hash of the one or more current settings applied to the second component of the industrial automation device.

19. The system of claim 17, wherein the computer-executable instructions stored in the memory, when executed by the authentication processor, further configure authentication processor for:
receiving, in response to granting the client access to the first component, one or more updated configuration settings associated with the first component;
applying, to the first component, the updated configuration settings;
generating, by the industrial automation device, updated first configuration information comprising the updated configuration settings; and
transmitting to the client the updated first configuration information.

20. The system of claim 17, wherein the request to access the industrial automation device comprises a client credential, wherein the authentication database further stores a plurality of valid client credentials, and wherein the computer-executable instructions stored in the memory, when executed by the authentication processor, further configure processor for validating the client credential against the stored valid client credentials.

21. The system of claim 20, wherein the client credential further comprises a client role and wherein the computer-executable instructions stored in the memory, when executed by the authentication processor, further configure authentication processor for:
comparing, after validating the client credential, the client role to one or more roles associated with the first component and one or more roles associated with the second component.

22. The system of claim 20, wherein the computer-executable instructions stored in the memory, when executed by the authentication processor, further configure authentication processor for:
soliciting, after receiving the request to access, a two-factor authentication response from the client, wherein the two-factor authentication response comprises at least one of a push notification or a PIN code.
